(19) United States
(12) Patent Application Publication
(10) Pub. No.: US 2026/0321232 A1
(43) Pub. Date: Oct. 15, 2026

(54) USER PREFERENCE CONTROLLED MUSIC GENERATION

(71) Applicant: SAMSUNG ELECTRONICS CO., LTD., Gyeonggi-Do (KR)

(72) Inventors: Xiangyuan Zhao, Irvine, CA (US); Yingnan Zhu, Irvine, CA (US); Anirudh Rao, Irvine, CA (US)

(21) Appl. No.: 19/179,358

(22) Filed: Apr. 15, 2025

(51) Int. Cl. G10H 1/00

(52) U.S. Cl. CPC G10H 1/0025; G10H 2240/105; G10H 2250/311

(57) ABSTRACT

User preference controlled music generation includes generating, by an encoder of a transformer model, a user behavior embedding from user behavior data. Semantic features are generated by a semantic data generation model from a received input. A behavioral semantic embedding is generated by processing the semantic features and the user behavior embedding through a cross-attention encoder. Control features are generated by combining the behavioral semantic embedding with context features generated from context data. A music generation model generates music based on the control features.

### TECHNICAL FIELD

This disclosure relates to automated music generation based on user preferences.

### BACKGROUND

Users consume a wide range of visual content using various devices. Examples of visual content may include, but is not limited to, movies, television shows, one or more images, a slideshow of a sequence of images, and/or artificially generated images and/or video. Typically, the audio content that plays back in synchronization with visual content, e.g., a soundtrack, is intended to appeal to a mass audience and does not reflect the individual preferences and/or tastes of different individual users consuming the content at any given time. As such, the audio/music played concurrently with visual content may be unsuitable or even unappealing to different individual users.

For example, the soundtrack for a movie or television show may be generally acceptable to most people that watch the movie or television show but may not be reflective of the individual taste of a particular user watching the media. In other cases, audio may be generated to accompany an image, a slideshow, or a montage. As an example, one's mobile device may automatically generate a slideshow or a montage of selected pictures stored on the user's mobile device in response to a detected event such as a birthday in the contacts of the mobile device. Music may be selected and played concurrently with the slideshow. Here too, the music selected for the slideshow may be generally applicable to the particular event, e.g., a birthday, but is not tailored to the individual user of the mobile device. That is, the slideshow generated for a birthday detected in one's mobile device may use music generally considered to be of a sentimental nature but otherwise have no relationship to the specific user preferences of the owner of the mobile device.

### SUMMARY

In one or more embodiments, a method includes generating, by an encoder of a transformer model, a user behavior embedding from user behavior data. The method includes generating, by a semantic data generation model, semantic features from a received input. The method includes generating a behavioral semantic embedding by processing the semantic features and the user behavior embedding through a cross-attention encoder. The method includes generating control features by combining the behavioral semantic embedding with context features generated from context data. The method includes generating, by a music generation model, music based on the control features.

In one or more embodiments, a system includes one or more processors configured to execute operations. The operations include generating, by an encoder of a transformer model, a user behavior embedding from user behavior data. The operations include generating, by a semantic data generation model, semantic features from a received input. The operations include generating a behavioral semantic embedding by processing the semantic features and the user behavior embedding through a cross-attention encoder. The operations include generating control features by combining the behavioral semantic embedding with context features generated from context data. The operations include generating, by a music generation model, music based on the control features.

In one or more embodiments, a computer program product includes one or more computer readable storage mediums, and program instructions collectively stored on the one or more computer readable storage mediums. The program instructions are executable by computer hardware to initiate operations. The operations include generating, by an encoder of a transformer model, a user behavior embedding from user behavior data. The operations include generating, by a semantic data generation model, semantic features from a received input. The operations include generating a behavioral semantic embedding by processing the semantic features and the user behavior embedding through a cross-attention encoder. The operations include generating control features by combining the behavioral semantic embedding with context features generated from context data. The operations include generating, by a music generation model, music based on the control features.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments; however, the accompanying drawings should not be taken to limit the disclosed technology to only the embodiments shown. Various aspects and advantages will become apparent upon review of the following detailed description and upon reference to the drawings.

FIG. 1 illustrates a music generation framework (framework) in accordance with one or more embodiments of the disclosed technology.

FIG. 2 illustrates the framework in accordance with one or more other embodiments of the disclosed technology.

FIG. 3 illustrates a method of automatically generating music in accordance with one or more embodiments of the disclosed technology.

FIG. 4 illustrates a regression model in accordance with one or more embodiments of the disclosed technology.

FIG. 5 illustrates certain aspects of training a transformer model in accordance with one or more embodiments of the disclosed technology.

FIG. 6 illustrates certain aspects of a semantic data generation model, a cross-attention encoder, and a music generation model in accordance with one or more embodiments of the disclosed technology.

FIG. 7 illustrates the cross-attention encoder in accordance with one or more embodiments of the disclosed technology.

FIG. 8 illustrates alternative aspects of the semantic data generation model, the cross-attention encoder, and the music generation model in accordance with one or more other embodiments of the disclosed technology.

FIG. 9 illustrates alternative aspects of the semantic data generation model, the cross-attention encoder, and the music generation model in accordance with one or more other embodiments of the disclosed technology.

FIG. 10 illustrates alternative aspects of the semantic data generation model, the cross-attention encoder, and the music generation model in accordance with one or more other embodiments of the disclosed technology.

FIG. 11 illustrates an example of a data processing system for use with the embodiments of the disclosed technology.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to automatic music generation based on user preferences. In accordance with the inventive arrangements disclosed herein, methods, systems, and computer program products are provided that are capable of automatically generating music. The music is generated based on user preferences. In some embodiments, the music is generated for a particular visual content item and based on the user preferences. In one or more other embodiments, the music may be generated based on other modalities of input such as text as well as user preferences.

The music that is generated may be rendered concurrently with rendering the visual content item or simply rendered (e.g., with or without an accompanying visual content item). For example, in cases where the visual content item includes no accompanying audio and/or music, the generated music may be rendered concurrently with the visual content item. In cases wherein the visual content item does have accompanying audio and/or music, the music that is generated may rendered concurrently with rendering the visual content item and played in place of one or more or all of the accompanying audio and/or music of the visual content item. In some examples, the generated music may be played in lieu of particular channels of audio and/or music for the visual content item.

One or more embodiments implement a user behavior prediction model that uses a regression transformer structure to predict future user behavior based on past user behavior data. Output from the encoder of the regression transformer structure may be used as a user behavior embedding. In some embodiments, the user behavior embedding may be combined with a personal media analysis of the user's media and used as a user preference embedding. An encoder only conditional diffusion model that implements a cross-attention based encoder structure may be used to generate control features for a music generation model. The control features may be generated from the user behavior embedding and/or the user preference embedding. Semantic features obtained from a visual content item for which the music is being generated also may be provided to the music generation model.

Embodiments of the disclosed technology are capable of generating music that conforms with user preferences to accompany visual content. Embodiments of the disclosed technology are capable of generating music across many different musical genres including, but not limited to, pop music, electronic music, country music, rock music, hip hop music, and/or k-pop music, while adhering to user-preferences. Further, as described in greater detail below, the embodiments of the disclosed technology are capable of generating music from inputs of diverse/different input modalities. These input modalities may include, but are not limited to, text, video, and images. In this regard, embodiments of the disclosed technology provide comprehensive frameworks that are operative to automatically generate music and/or enhanced media in accordance with user preferences based on any of a variety user inputs thereby providing customized music to users and delivering users an improved media experience.

Further aspects of the disclosed technology are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

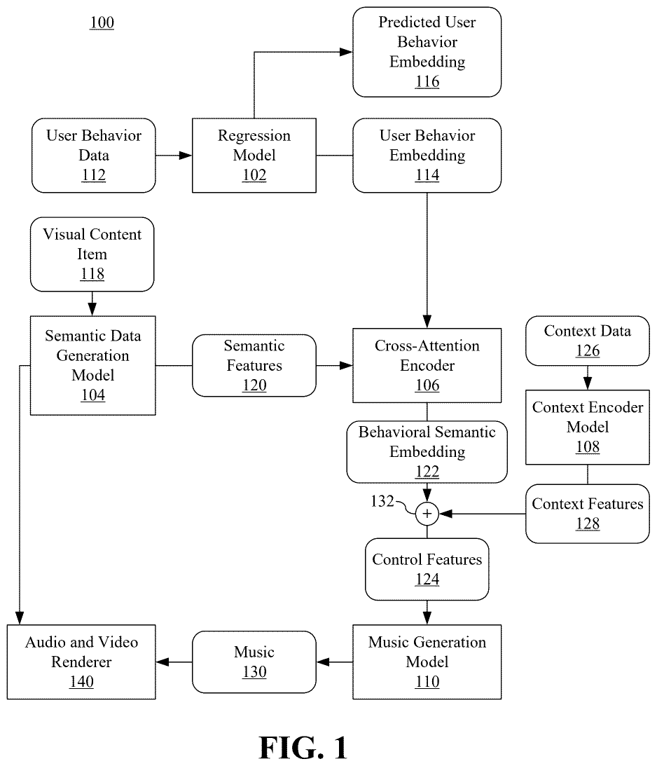

FIG. 1 illustrates a music generation framework (framework) 100 in accordance with one or more embodiments of the disclosed technology. Framework 100 may be executed in a computing device such as a data processing system, an information appliance, or other device with computing capabilities. In some examples, framework 100 may execute across a plurality of devices, e.g., two or more devices, that operate in coordination/cooperation with one another. Examples of information appliances may include, but are not limited to, electronic display devices such as televisions, tablet computers, mobile phones/devices, or other devices capable of rendering (e.g., displaying) video content and/or rendering (e.g., playing) audio content.

In the example of FIG. 1, framework 100 implements a regression transformer structure as regression model 102. Regression model 102 is capable of predicting future user behavior and uses the encoding feature of the regression transformer to process user behavior data. Framework 100 further implements an encoder only, conditional diffusion model capable of music generation. In the example, the encoder only, conditional diffusion model mode includes cross-attention encoder 106, context encoder model 108, and music generation model 110.

In the example, regression model 102 is capable of generating a user behavior embedding 114 from user behavior data 112. Regression model 102 is capable of receiving user behavior data 112, which specifies past or historical user behavior data, and uses an autoregressive transformer model structure, or portion thereof, to generate user behavior embedding 114. Regression model 102 also may generate predicted user behavior embedding 116 autoregressively from user behavior data 112 by predicting next elements in the sequence of elements specified by user behavior data 112 in an iterative manner. Predicted user behavior embedding 116 specifies a prediction of future user behavior.

User behavior data 112 may include data from one or more different sources (e.g., devices of a user). For purposes of illustration, user behavior data 112 may include usage data for a user obtained from sources such as a television (e.g., a smart television), a mobile phone, one or more information and/or smart appliances, one or more wearable devices (e.g., smart glasses, ear buds), or the like, that the user owns and/or users. User behavior data 112 may be obtained from Internet-of-Things (IoT) enabled devices, devices compatible with SMARTTHINGS technology and/or other similar or equivalent data sharing and/or communication paradigms. The actual user behavior data 112 may specify particular content, e.g., music, video, images, applications, Web pages, etc., consumed by the user on such devices. User behavior data 112 may include historical data for these various devices and, as such, have time and/or data stamps indicating when such information was collected or sampled from the source. In another example, user behavior data 112, at least as obtained from a television or other device capable of rendering video and/or images, may be obtained from using Automatic Content Recognition technology that is capable of collecting viewing data to detect what content is being viewed on a particular device such as a television. In the example of FIG. 1, any user behavior data obtained may be obtained with permission of the user.

In one or more embodiments, while a regression model implemented as an autoregressive transformer model includes an encoder and a decoder, once trained for use with the embodiments described herein, only the encoder of regression model 102 is needed for music generation. The bottleneck or connection between the encoder and the decoder of regression model 102 may be adapted to output user behavior embedding 114. That is, the encoder of regression model 102 may output user behavior embedding 114. In the example of FIG. 1, user behavior embedding 114 may be used for purposes of music generation. Predicted user behavior embedding 116 may be output from the encoder of regression model 102. Predicted user behavior embedding 116, however, is not required for music generation and may be used for other purposes such as, for example, generating recommendations for the user and/or for other analysis purposes.

In the example of FIG. 1, the input provided to framework 100 that prompts music generation may be a particular item of visual content for which music 130 is to be automatically generated. This input is illustrated in FIG. 1 as visual content item 118. Visual content item 118 is provided as an input to a semantic data generation model 104. Semantic data generation model 104 may include one or more models and is capable of processing visual content item 118 to generate semantic features 120. Visual content item 118 is an example of an input. Other example inputs are described herein and may specify data of one or more other modalities.

Context encoder model 108 is capable of receiving context data 126. Context data 126 may be obtained by one or more sensors of the system implementing framework 100, one or more services executing in the system implementing some or all of framework 100, or a combination thereof. In one or more other examples, such services may be configured, or executable, to provide context data 126 about the period of time or moment(s) in which music generation is occurring or is to be performed. Context data 126, for example, may specify information such as a current time, the current date, the day of the week, the season, current weather conditions (e.g., temperature, precipitation, wind speed, sunny, rainy, overcast, etc.), or the like. Context encoder model 108 is capable of encoding context data 126 to generate context features 128.

Cross-attention encoder 106 is capable of receiving user behavior embedding 114 and semantic features 120. Based on both received inputs, cross-attention encoder 106 is capable of generating behavioral semantic embedding 122. Behavioral semantic embedding 122 may be combined with context features 128 resulting in control features 124. In the example, context features 128 may be concatenated with behavioral semantic embedding 122 by concatenator 132. Control features 124 are provided to music generation model 110. Music generation model 110, based, at least in part, on control features 124, is capable of generating music 130.

In the example of FIG. 1, visual content item 118 and music 130 may be provided to an audio and video renderer (renderer) 140. Renderer 140 is capable of rendering visual content item 118 and music 130 concurrently. More particularly, renderer 140 is capable of rendering, e.g., displaying, visual content item 118 via a display device or screen of the device and/or system implementing some or all of framework 100. Renderer 140 is capable of rendering, e.g., playing, music 130 via a sound system having a transducer (e.g., speaker) incorporated in the device/system implementing some or all of framework 100.

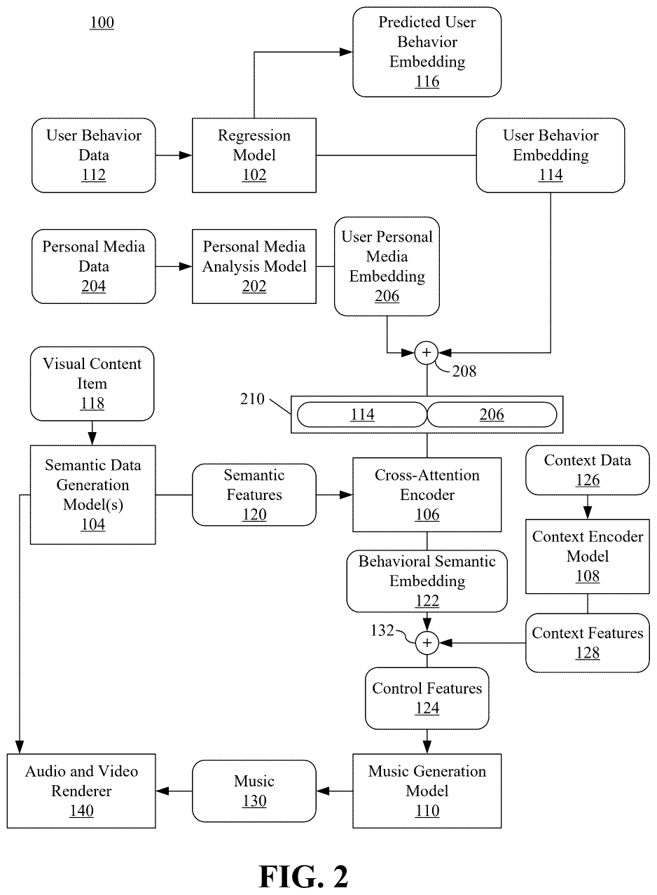

FIG. 2 illustrates framework 100 in accordance with one or more other embodiments of the disclosed technology. In the example of FIG. 2, framework 100 incorporates personal media preferences into the automated music generation process. In the example, a personal media analysis model 202 is capable of operating on personal media data 204 to generate a user personal media embedding 206, which may be combined with user behavior embedding 114. As illustrated, a concatenator 208 is capable of concatenating user behavior embedding 114 with user personal media embedding 206 resulting in a user preference embedding 210. In the example of FIG. 2, user preference embedding 210 is provided as input to cross-attention encoder 106 with semantic features 120 to generate behavioral semantic embedding 122. Control features 124 are generated as described in connection with FIG. 1. In the example of FIG. 2, by including personal media data 204 into the process of generating control features 124, music 130 that is generated may be more reflective of personal media preferences of the user.

In one or more embodiments, personal media analysis model 202 may be a system, e.g., an existing system, that is running on one or more devices of user that is configured to provide data to framework 100. As an illustrative and nonlimiting example, framework 100 may execute in whole or in part on a television or other data processing system/device capable of rendering visual content and audio content. Personal media analysis model 202 may execute on a user's personal device such as a mobile phone, a tablet computer, or the like. Personal media analysis model 202, for example, may be implemented as a service that is capable of creating movies, photo slideshows, and/or photo montages on a user's mobile phone. Such services are capable of evaluating metadata and/or actual content on the user's device. The services may include an Application Programming Interface (API) through which framework 100 may access the metadata generated from the analysis in feature form, e.g., as user personal media embedding 206. As an illustrative and nonlimiting example, personal media analysis model 202 may be implemented as the BIXBY artificial intelligence assistant from Samsung Electronics Co. Ltd.

By also using user personal media embedding 206 to generate control features 124, the music 130 that is generated by music generation model 110 may be further enhanced and/or personalized to the individual tastes of the user.

Framework 100 as illustrated in FIGS. 1 and/or 2 may be used to generate music for video, an image, a slideshow, a montage, a screensaver, etc. that may be displayed on a display device. The particular visual content item may be a commercially available item, e.g., a motion picture movie or television/streaming show or content item, or an item that was created or fully owned by the user (e.g., a personal video of a personal event such as a wedding). In some examples, framework 100 may be used to generate music for art deco images or other situations where music is needed for ambience and/or to enhance user experience. Some devices, for example, may display images or other visualizations in an ambient mode for which framework 100 may generate music.

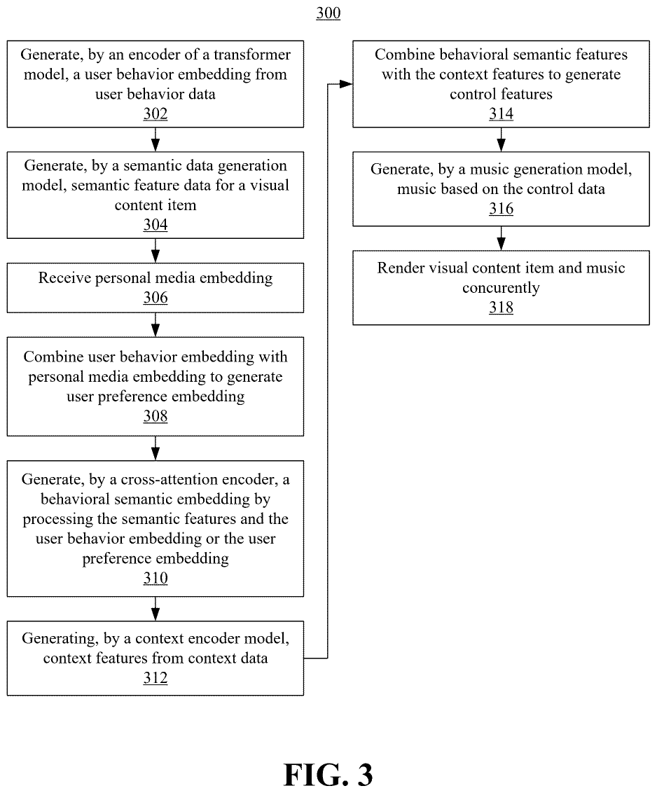

FIG. 3 illustrates a method 300 of automatically generating music in accordance with one or more embodiments of the disclosed technology. Method 300 may be implemented by the example framework 100 of FIG. 1 or of FIG. 2.

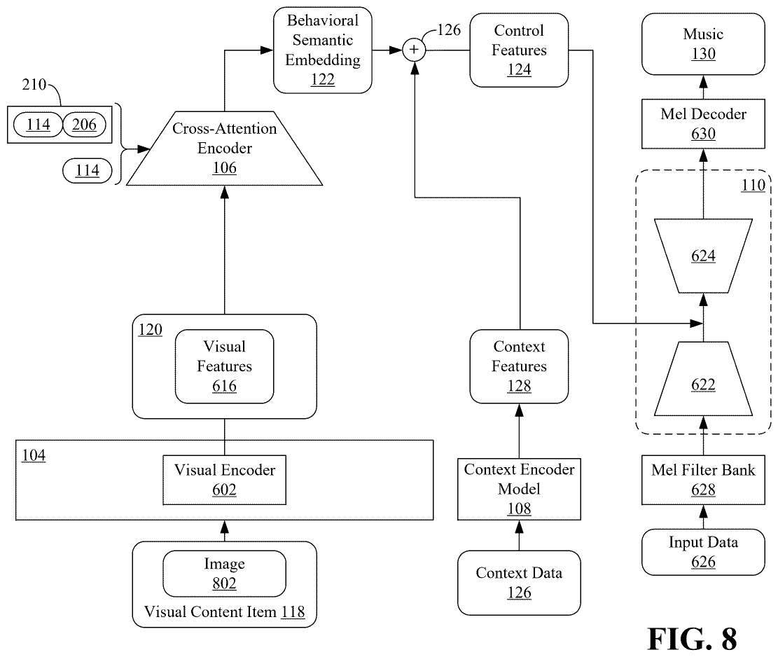

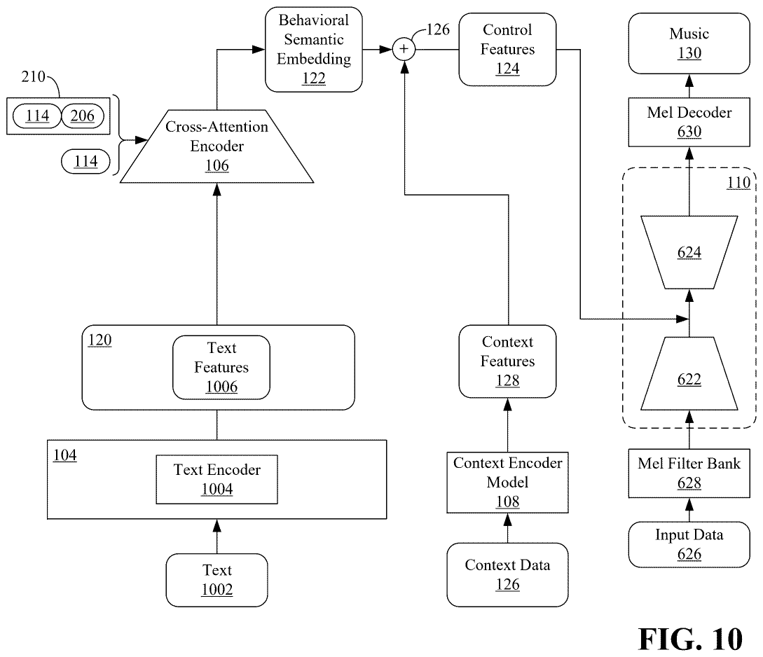

In block 302, an encoder of a transformer model is capable of generating a user behavior embedding 114 from user behavior data 112. In block 304, semantic data generation model 104 is capable of generating semantic features 120 for an input. The input may be visual content item 118 or inputs of other modalities as described in connection with FIGS. 8 and 10.

In block 306, framework 100 optionally receives user personal media embedding 206. In block 308, in the case where user personal media embedding 206 is received, user personal media embedding 206 is combined with user behavior embedding 114 resulting in user preference embedding 210.

In block 310, in embodiments where personal media embedding 206 is not received or utilized, cross-attention encoder 106 processes semantic features 120 and user behavior embedding 114 to generate behavioral semantic embedding 122. In embodiments where user personal media embedding 206 is received or available, user personal media embedding 206 is combined with user behavior embedding 114 to generate user preference embedding 210. In that case, cross-attention encoder 106 processes semantic features 120 and user preference embedding 210 to generate behavioral semantic embedding 122.

In block 312, context encoder model 108 processes context data 126 thereby generating context features 128. In block 314, the context features 128 are combined with behavioral semantic embedding 122 to generate control features 124. In block 316, music generation model 110 is capable of generating music 130 for the input, e.g., visual content item 118, based on control features 124. In one or more examples, music generation model 110 may be implemented as an encoder of a conditional diffusion model.

In block 318, renderer 140 is capable of rendering visual content item 118 and music 130 concurrently. In one or more embodiments, visual content item 118 includes no audio and/or musical soundtrack or accompaniment. For example, visual content item 118 may be an image or scene, a slideshow or montage, or a video without any audio or music accompaniment. In that case, music 130 may be played as the accompaniment for visual content item 118. In one or more other embodiments, music 130 may be played in place of, or overlapping with, audio, music, or accompaniment of visual content item 118. In one or more other embodiments, music 130 may be played in place of a particular track or time segment of audio, music, or accompaniment of visual content item 118.

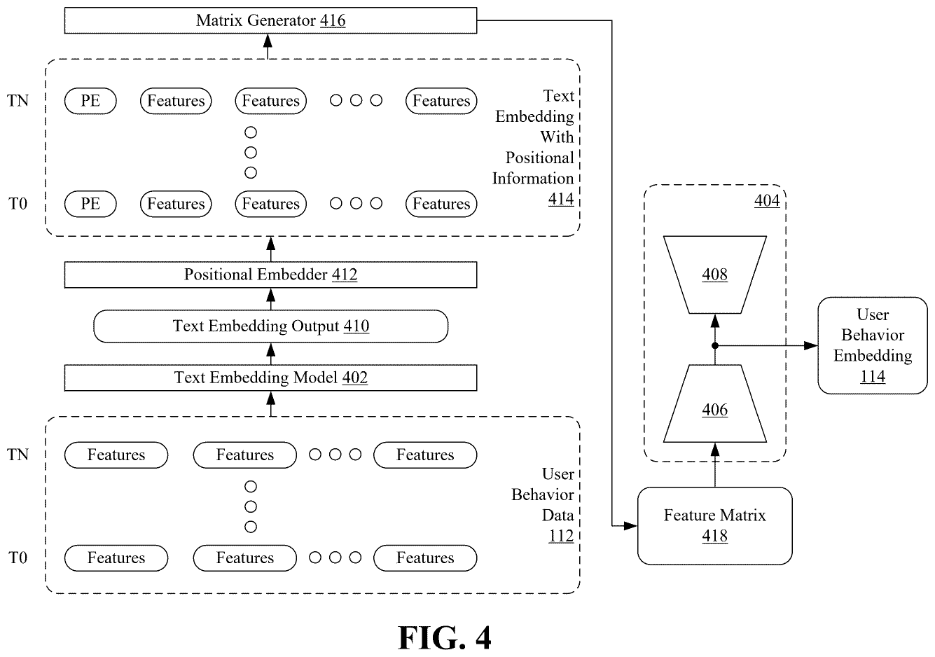

FIG. 4 illustrates regression model 102 in accordance with one or more embodiments of the disclosed technology. In the example of FIG. 4, regression model 102 includes a text embedding model 402, a transformer model 404, a positional embedder 412, and a matrix generator 416. Transformer model 404 includes an encoder 406 and a decoder 408.

As illustrated, user behavior data 112 may include a plurality of different features obtained at different points in time illustrated as T₀ through T_{N}. Examples of the features that may be specified by user behavior data 112 may include, but are not limited to, genre of content that was consumed, the title of the content consumed, the artist of the content consumed, the cast of the content consumed, and/or other metadata (e.g., producers, directors, recording engineers, etc.).

Text embedding model 402 receives the sequence of user behavior data 112 as input. As illustrated, user behavior data 112 may be processed through text embedding model 402 to generate text embedding output 410. Text embedding model 402 may be implemented as a text-to-text transformer. In one or more embodiments, text embedding model 402 may be implemented as the encoder of a text-to-text transformer. An example implementation of text embedding model 402 may include, but is not limited to, the T5 model or the T5-Base model (or the encoder of the model) as described in Raffel, et al., “Exploring the Limits of Transfer Learning with a Unified Text-to-Text Transformer.” In this regard, text embedding model 402 is capable of performing a semantic analysis of user behavior data 112, which is reflected or specified in output 410.

Positional embedder 412 may be implemented as a processing layer that is capable of embedding time-based positional information into text embedding output 410. For example, positional embedder 412 is capable of embedding the position (e.g., a sequence number corresponding to the time T₀ through T_{N} of each features set) into text embedding output 410 resulting in text embedding with positional information (TEPI) 414. In TEPI 414, the time-based positional information is illustrated for each row or features set corresponding to a given time as “PE” for positional embedding. TEPI 414 may be provided to another processing layer illustrated as matrix generator 416 that outputs a feature matrix 418. Feature matrix 418 is provided to transformer model 404 and, more particularly, to encoder 406 as input. As illustrated, the output taken from encoder 406 is user behavior embedding 114.

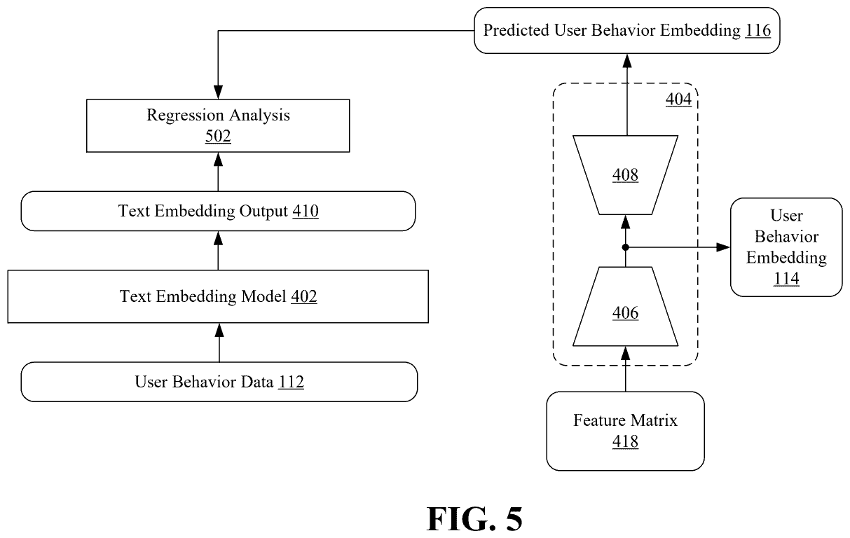

FIG. 5 illustrates certain aspects of training transformer model 404 in accordance with one or more embodiments of the disclosed technology. As discussed, during runtime or inference, only encoder 406 of transformer model 404 is needed or used to generate user behavior embedding 114. In one or more embodiments, decoder 408 may be used during runtime or inference for other purposes such as providing recommendations.

In the example of FIG. 5, for purposes of training, text embedding model 402 processes user behavior data 112 to generate text embedding output 410. In the example, feature matrix 418 is generated based on user behavior data 112 from times T₀ through T_{N}. For purposes of training transformer model 404, the output of decoder 408 is an embedding specifying a prediction of future user behavior illustrated as predicted user behavior embedding 116. Predicted user behavior embedding 116 specifies an embedding of predicted future user behavior at time T_{N+1}. Transformer model 404 may be trained by adjusting weights and biases of encoder 406 and decoder 408 based on a comparison of predicted user behavior embedding 116 with the ground truth. The ground truth is text embedding output 410 generated from actual user behavior data 112 at time T_{N+1}. Regression analysis 502 is capable of implementing regression learning to perform functions such as comparing the ground truth with the predicted user behavior and, based on the comparison, adjusting biases and weights of encoder 406 and decoder 408. The process may iterate until the error detected by regression analysis 502 reaches an acceptable level over further predicted user behavior embeddings 116 at times T_{N+2}, T_{N+3}, etc.

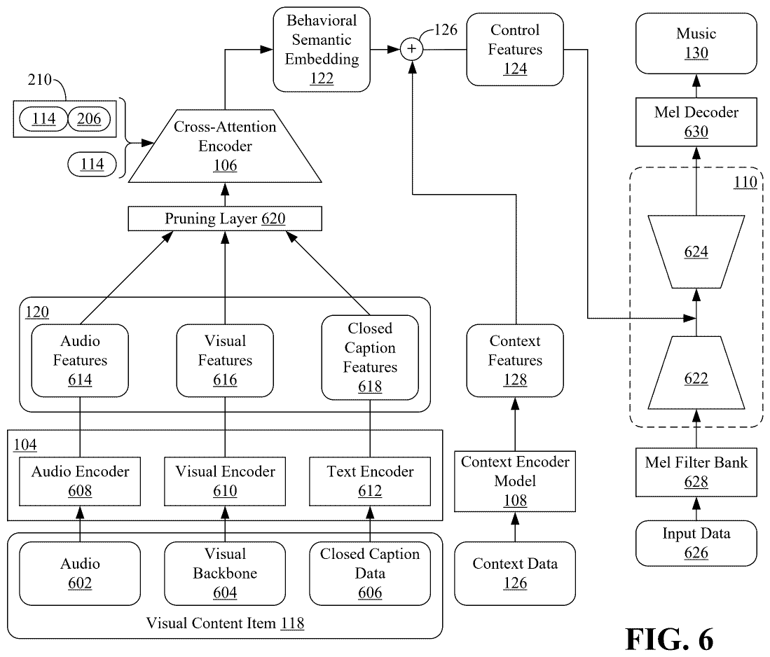

FIG. 6 illustrates certain aspects of semantic data generation model 104, cross-attention encoder 106, and music generation model 110 in accordance with one or more embodiments of the disclosed technology. In the example of FIG. 6, visual content item 118 may be implemented as video that includes multiple channels of data. Each channel may represent a different modality of data. For example, the video may include one or more audio channels (audio 602), video illustrated as a visual backbone 604, and a closed captioning channel (e.g., timed or synchronized text) illustrated as closed caption data 606. Visual back bone 604 refers to the sequence of frames/images of a visual content item (e.g., video). In this regard, the term “visual backbone” excludes other data or channels of the visual content item such as audio and closed captioning and refers only to the sequence of frames/images.

In the example, semantic data generation model 104 may be implemented as a plurality of different encoders. Each of the encoders may be specific to the data type (modality) processed and, as illustrated, a particular channel of information of visual content item 118. As illustrated, audio encoder 608 is capable of processing audio 602 to generate audio features 614. An example of audio encoder 608 may be Whisper from OpenAI of San Franscisco, CA, as discussed in Radford et al., “Robust Speech Recognition via Larg-Scale Weak Supervision” (2022) or Contrastive Language-Audio Pretraining (CLAP) as described in Wu et al., “Large-Scale Contrastive Language-Audio Pretraining with Feature Fusion and Keyword-to-Caption Augmentation” (2024).

Visual encoder 610 is capable of processing visual backbone 604 to generate visual features 616. An example of visual encoder 610 may be Video Vision Transform (ViViT) as disclosed in Arnab et al., “ViViT: A Video Vision Transformer” (2021). Text encoder 612 is capable of processing closed caption data 606 to generate closed caption features 618. Texte encoder 612 may be implemented using the T5 or T5 Base model(s). In the example of FIG. 6, semantic features 120 includes audio features 614, visual features 616, and closed caption features 618. The example models provided herein are not intended to be limited as any of a variety of known models may be used to generate the various relevant features described herein.

In one or more embodiments, semantic features 120 may be provided to a pruning layer 620. Pruning layer 620 may be an optional layer and in some embodiments may be omitted such that semantic features 120 are provided directly to cross-attention encoder 106.

In embodiments where pruning layer 620 is used, pruning layer 620 is capable of pruning, e.g., removing or discarding, one or more of semantic features 120 prior to use of the semantic features 120 by cross-attention encoder 106. Pruning layer 620 is capable of reducing imbalances in information between different modalities (e.g., audio, video, closed captioning) or channels of visual content item 118 and reducing the amount of semantic features 120 that requires processing (e.g., reducing memory requirements of framework 100). As an example, there may be no audio 602 for one or more segments of the visual backbone 604. Audio 602 may include dialog, sound effects, music, or various combinations thereof. In segments without dialog, there will be no closed caption data. Pruning layer 620 is capable of addressing these imbalances by assigning different importance scores to different modalities based on what is detected by the respective encoders. Appreciably, each encoder may be trained for the particular channel of data (e.g., modality) that it is processing. In this regard, audio encoder 608 will encode sound effects, music, and/or dialog differently such that the resulting embedding conveys semantic information that may be interpreted as being one or more or any combination of, for example, sound effects, music, and/or dialog.

In one or more embodiments, pruning layer 620 is capable of performing a hard pruning by setting features to 0 in cases where the features do not exceed a predetermined threshold. Different thresholds may be applied to each different channel and corresponding feature data. In one or more other embodiments, pruning layer 620 is capable of performing a soft pruning. Soft pruning may be implemented as a softmax function that is capable of predicting an importance score for each modality of feature data and multiplying the feature data of each respective modality with the computed importance score for that modality. Appreciably, the scores may change for each modality over time. In either the hard pruning implementation or the soft pruning implementation, the parameters of pruning layer 620 may be learned parameters through training.

As an example, consider a scene of visual content item 118 in which there is no dialog and only sound effects. The sound effects may not be significant to the scene and/or may not be significant for purposes of music generation. For example, the audio may be considered, or akin to, noise. In that case, if hard pruning is used, the audio features may be assigned 0 values. In that case, no audio features will be used or included in semantic features 120 to contribute to music creation. In this example, semantic features 120 may be derived completely from the video backbone (e.g., visual features 616).

In another example, a scene may some dialog and closed caption data. In this example, the dialog and close caption data may be sparse over the time period of the scene, yet be considered important. In this example, pruning layer 620 may increase the importance of audio features 614 and/or closed caption features 618. Without pruning layer 620 increasing the importance, because the dialog and closed caption data is sparse (e.g., span 10 seconds of a scene that is 5 minutes), these features may be zeroed out. Pruning layer 620 prevents them from being zeroed out and may increase their importance. Accordingly, audio features 614 and/or closed caption features 618 will influence music generation.

Cross-attention encoder 106 is capable of operating on the received features as input. In one or more embodiments, cross-attention encoder 106 receives user behavior embedding 114. In that case, cross-attention encoder 106 generates behavioral semantic embedding 122 from user behavior embedding 114 and from semantic features 120 (which may or may not be pruned). In one or more other embodiments, cross-attention encoder 106 receives user preference embedding 210 (e.g., user behavior embedding 114 and user personal media embedding 206). In that case, cross-attention encoder 106 generates behavioral semantic embedding 122 from user behavior embedding 114 and from user preference embedding 210.

In the example, behavioral semantic embedding 122 is combined with context features 128 to generate control features 124. In the example, concatenator 132 is capable of concatenating behavioral semantic embedding 122 with context features 128. As illustrated, control features 124 may be provided to music generation model 110.

In one or more embodiments, music generation model 110 is implemented as diffusion model. As an illustrative and nonlimiting example, music generation model 110 may be implemented as a U-Net Diffusion Model trained to generate music. As generally known, a U-Net model is a convolutional neural network that may be trained to generate music. In the example, music generation model 110 includes an encoder 622 and a decoder 624. In the example of FIG. 6, control features 124 are provided to music generation model 110 and, more particularly, as input to decoder 624.

For purposes of illustration, music generation model 110 is provided with input data 626. Input data 626 may be music of some sort, noise, or the like. Input data 626 is provided to a mel-frequency cepstrum filter bank (shown as Mel Filter Bank) 628, which is capable of outputting mel-frequency cepstrum coefficients that may be provided to encoder 622 as input. In generating music 130, it should be appreciated that control features 124 will largely dominate the music creation such that the particular input data 626 provided to encoder 622 (e.g., as processed through mel filter bank 628) is not determinative of the type or quality of music 130 that is ultimately generated. The output generated by decoder 624 is provided to mel-frequency cepstrum decoder (mel decoder) 630, which translates the mel-frequency cepstrum coefficients output from decoder 624 into audible sound, e.g., music 130.

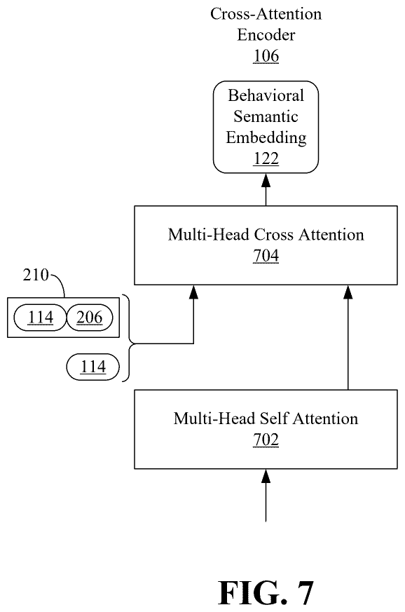

FIG. 7 illustrates cross-attention encoder 106 in accordance with one or more embodiments of the disclosed technology. In the example of FIG. 7, cross-attention encoder 106 receives data as semantic features 120 or a pruned version thereof in embodiments where pruning layer 620 is included. Cross-attention encoder 106 includes a multi-head self-attention 702 and a multi-head cross-attention 704.

Multi-head self-attention 702 is capable of running N different self-attention mechanisms concurrently, e.g., in parallel. Each self-attention mechanism, e.g., “head,” is capable of learning a different attention in reference to different patterns and/or relationships in the input data. Each head, for example, has a different projection of queries (Q), keys (K), and values (V). This facilitates each position in a set of features provided as input being considered in relation to each other position in the set of features. For multi-head self-attention 702, the query, key, and value come from the same sequence (e.g., feature set corresponding to semantic features 120). The output from each head is concatenated together and output from multi-head self-attention 702 and provided to multi-head cross-attention 704.

In the example, the output generated by multi-head self-attention 702 is provided to multi-head cross-attention 704 as the keys and values. The query provided to multi-head cross-attention 704 is user behavior embedding 114 or, in the alternative, both user behavior embedding 114 and user personal media embedding 206 as user preference embedding 210. Multi-head cross-attention 704 is operative such that one sequence such as the query attends to the other sequences (e.g., the key and value). In the case of multi-head cross-attention 704, the query does not come from the same sequence (e.g., feature set) as the key and value. In this regard, multi-head self-attention 702 is capable of selecting particular features of semantic features 120 considered to be of greater importance while multi-head cross-attention 704 is capable of selecting particular features from semantic features 120 and either user behavior embedding 114 or, in the alternative, user preference embedding 210 considered to be of greater importance as reflected, or specified, in behavioral semantic embedding 122.

FIG. 8 illustrates alternative aspects of semantic data generation model 104, cross-attention encoder 106, and music generation model 110 in accordance with one or more other embodiments of the disclosed technology. In the example of FIG. 8, visual content item 118 may be an image 802. In this example, semantic data generation model 104 may be implemented as visual encoder 610 and semantic features 120 will include only visual features 616 corresponding to image 802. The remainder of FIG. 8 may operate the same as or substantially similar the example described in connection with FIG. 6. In the example of FIG. 8, framework 100 is capable of generating music 130 based on an image, e.g., a single image.

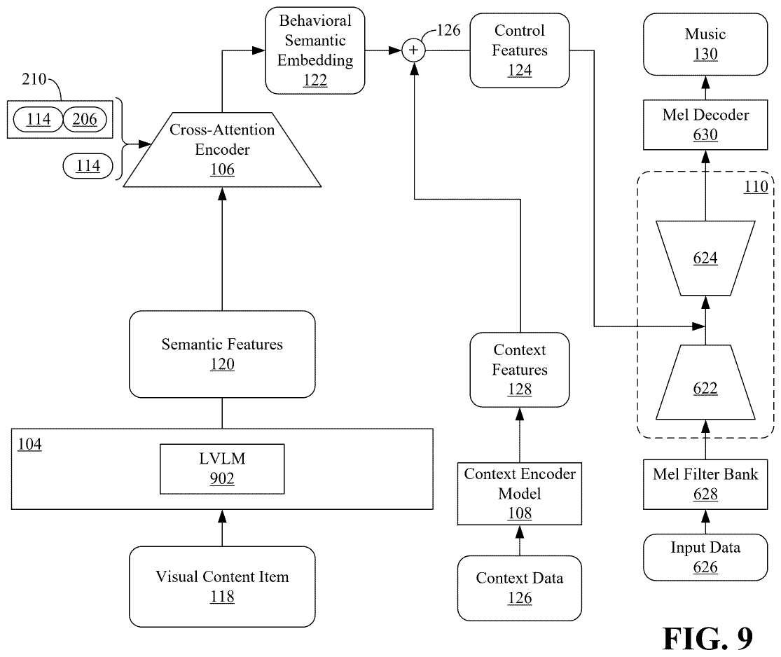

FIG. 9 illustrates alternative aspects of semantic data generation model 104, cross-attention encoder 106, and music generation model 110 in accordance with one or more other embodiments of the disclosed technology. In the example of FIG. 9, visual content item 118 may be a video. The video may include one or more audio channels, a video backbone, and optionally a closed captioning channel. In this example, semantic data generation model 104 may be implemented as a Large Vision-Language Model (LVLM) 902. An example implementation of LVLM 902 is described in Xu, et al., “LVLM-eHub: A Comprehensive Evaluation Benchmark for Large Vision-Language Models,” (2023). LVLM 902 is capable of understanding and responding to visual information and textual information. In the example, LVLM 902 generates semantic features 120 that are provided to cross-attention encoder 106. The remainder of FIG. 9 may operate the same as or substantially similar to the example described in connection with FIG. 6. In the example of FIG. 9, framework 100 is capable of generating music 130 based on a video using a single, larger semantic model 104.

FIG. 10 illustrates alternative aspects of semantic data generation model 104, cross-attention encoder 106, and music generation model 110 in accordance with one or more other embodiments of the disclosed technology. In the example of FIG. 10, text 1002 is provided to semantic data generation model 104 as input in lieu of visual content item 118. Text 1002 may be a description of user desired characteristics or features of the music to be generated. The user may specify mood, tempo, genre, other stylistic information, example artists, instrumentation, and the like. In other examples, the user may specify other information not specifically related to music such as the user's current mood or state of mind. The user may provide any combination of such information and/or other information in the form of text. Appreciably, the text may be speech recognized text. In this example, semantic data generation model 104 may be implemented as a text encoder 1004 (e.g., any of the text encoders described herein). Text encoder 1004 is capable of generating text features 1006 (e.g., a text embedding) that may be provided as input to cross-attention encoder 106. The remainder of FIG. 10 may operate the same or substantially similar to the example described in connection with FIG. 6. In the example of FIG. 10, framework 100 is capable of generating music 130 based on textual description of user desired characteristics or features of the music to be generated.

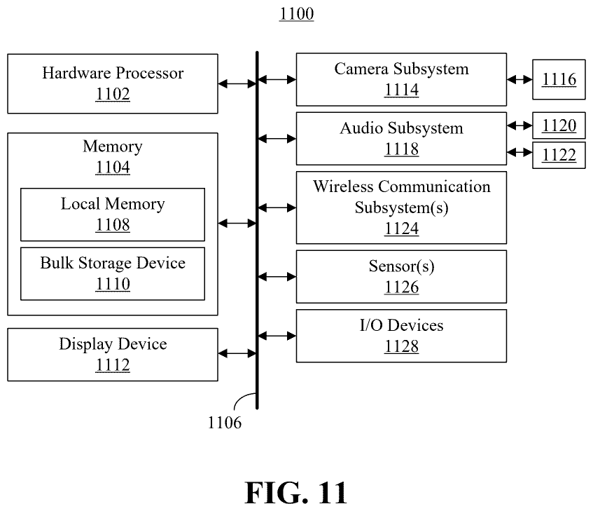

FIG. 11 illustrates an example of a data processing system 1100. Data processing system 1100 is an example of a device/system/apparatus that is capable of executing framework 100 of FIG. 1 or 2 or portions thereof. For example, one or more of the various models of framework 100 may execute in other computing systems that are coupled to, or communicatively linked with, data processing system 1100. Data processing system 1100 is an example of a hardware architecture, e.g., computing/computer hardware, that may implement any of the various systems and/or devices described herein and/or others not enumerated herein. For example, televisions (e.g., smart televisions), information appliances, computer systems, or other devices capable of rendering audio (e.g., playing music) and/or rendering visual material (e.g., displaying visual material) such as images and/or video may be implemented as data processing system 1100. In some examples, data processing system 1100 may be included and/or embedded in another larger system such as an automobile, a virtual reality system, or an augmented reality system.

Data processing system 1100 includes at least one (e.g., one or more) hardware processors 1102. Hardware processor 1102 is coupled to memory 1104 through interface circuitry 1106. Data processing system 1100 is capable of storing computer readable instructions (also referred to as “program code”) within memory 1104. Memory 1104 is an example of computer readable storage media. Hardware processor 1102 is capable of executing the program code accessed from memory 1104 via interface circuitry 1106.

Memory 1104 includes one or more physical memory devices such as, for example, a local memory 1108 and a bulk storage device 1110. Local memory 1108 is implemented as non-persistent memory device(s) generally used during actual execution of the program code. Examples of local memory 1108 include random access memory (RAM) and/or any of the various types of RAM that are suitable for use by a hardware processor during execution of program code. Bulk storage device 1110 is implemented as a persistent data storage device. Examples of bulk storage device 1110 include a hard disk drive (HDD), a solid-state drive (SSD), flash memory, a read-only memory (ROM), an erasable programmable read-only memory (EPROM), electrically erasable programmable read-only memory (EEPROM), or other suitable memory. Data processing system 1100 may include one or more cache memories (not shown) that provide temporary storage of at least some program code in order to reduce the number of times program code must be retrieved from a bulk storage device during execution.

Memory 1104 may store program code that is executable by hardware processor 1102. For example, memory 1104 may store framework 100 or portions thereof that are to be executed by hardware processor 1102 in automatically generating music based on user preferences. Appreciably, memory 1104 may store other program code that is executable by hardware processor 1102 such as, for example, an operating system and/or one or more applications.

Examples of interface circuitry 1106 include, but are not limited to, an input/output (I/O) subsystem, an I/O interface, a bus system, and a memory interface. For example, interface circuitry 1106 may be implemented as any of a variety of bus structures and/or combinations of bus structures including a memory bus or memory controller, a peripheral bus, an accelerated graphics port, and a processor or local bus.

In one or more embodiments, hardware processor 1102, memory 1104, and/or interface circuitry 1106 are implemented as separate components. In one or more embodiments, hardware processor 1102, memory 1104, and/or interface circuitry 1106 are integrated in one or more integrated circuits. The various components in data processing system 1100, for example, can be coupled by one or more communication buses or signal lines (e.g., interconnects and/or wires). In particular embodiments, memory 1104 is coupled to interface circuitry 1106 via a memory interface, e.g., a memory controller (not shown). In one or more other examples, data processing system 1100 may include additional processors such as, for example, Digital Signal Processors and/or Graphics Processing Units.

Data processing system 1100 may include one or more displays. In the example of FIG. 11, data processing system 1100 includes a display 1112 (e.g., a screen). Display 1112 may be implemented using any of a variety of available display technologies. In some examples, display 1112 is implemented as a touch-sensitive or touchscreen display capable of receiving touch input from a user. In any case, display 1112 is capable of displaying or rendering visual content such as visual content item 118.

In some examples, data processing system 1100 includes a camera subsystem 1114. Camera subsystem 1114 can be coupled to interface circuitry 1106 directly or through a suitable input/output (I/O) controller. Camera subsystem 1114 can be coupled to an optical sensor 1116. Optical sensor 1116 may be implemented using any of a variety of technologies. Examples of optical sensor 1116 can include, but are not limited to, a charged coupled device (CCD) or a complementary metal-oxide semiconductor (CMOS) optical sensor. Camera subsystem 1114 and optical sensor 1116 are capable of performing camera functions such as recording images and/or recording video.

Data processing system 1100 may include an audio subsystem 1118. Audio subsystem 1118 can be coupled to interface circuitry 1106 directly or through a suitable input/output (I/O) controller. Audio subsystem 1118 can be coupled to a speaker 1120 and optionally a microphone 1122 to facilitate voice-enabled functions, such as voice recognition, voice replication, digital recording, and telephony functions. Accordingly, music 130 may be played or rendered through audio subsystem 1118 and speaker 1120. Further, user input such as text 1002 may be received as user spoken utterances that are converted to speech-recognized text.

Data processing system 1100 may include one or more wireless communication subsystems 1124. Each of wireless communication subsystem(s) 1124 can be coupled to interface circuitry 1106 directly or through a suitable I/O controller (not shown). Each of wireless communication subsystem(s) 1124 is capable of facilitating communication functions. Examples of wireless communication subsystems 1124 can include, but are not limited to, radio frequency receivers and transmitters, and optical (e.g., infrared) receivers and transmitters. The specific design and implementation of wireless communication subsystem 1124 can depend on the particular type of data processing system 1100 implemented and/or the communication network(s) over which data processing system 1100 is intended to operate.

As an illustrative and non-limiting example, wireless communication subsystem(s) 1124 may be designed to operate over one or more mobile networks (e.g., GSM, GPRS, EDGE), a WiFi network which may include a WiMax network, a short-range wireless network (e.g., a Bluetooth network), and/or any combination of the foregoing. Wireless communication subsystem(s) 1124 can implement hosting protocols such that data processing system 1100 can be configured as a base station for other wireless devices.

Data processing system 1100 may include one or more sensors 1126. Each of sensors 1126 can be coupled to interface circuitry 1106 directly or through a suitable I/O controller (not shown). Examples of sensors 1126 that can be included in data processing system 1100 include, but are not limited to, a motion sensor, a light sensor, and a proximity sensor to facilitate orientation, lighting, and proximity functions, respectively, of data processing system 1100. Other examples of sensors 1126 can include, but are not limited to, a location sensor (e.g., a GPS receiver and/or processor) capable of providing geo-positioning sensor data, an electronic magnetometer (e.g., an integrated circuit chip) capable of providing sensor data that can be used to determine the direction of magnetic North for purposes of directional navigation, an accelerometer capable of providing data indicating change of speed and direction of movement of data processing system 1100 in 3-dimensions, and an altimeter (e.g., an integrated circuit) capable of providing data indicating altitude.

Data processing system 1100 further may include one or more input/output (I/O) devices 1128 coupled to interface circuitry 1106. I/O devices 1128 may be coupled to data processing system 1100, e.g., interface circuitry 1106, either directly or through intervening I/O controllers (not shown). Examples of I/O devices 1128 include, but are not limited to, a track pad, a keyboard, a display device, a pointing device, one or more communication ports (e.g., Universal Serial Bus (USB) ports), a network adapter, and buttons or other physical controls. A network adapter refers to circuitry that enables data processing system 1100 to become coupled to other systems, computer systems, remote printers, and/or remote storage devices through intervening private or public networks. Modems, cable modems, Ethernet interfaces, and wireless transceivers not part of wireless communication subsystem(s) 1124 are examples of different types of network adapters that may be used with data processing system 1100. One or more of I/O devices 1128 may be adapted to control functions of one or more or all of sensors 1126 and/or one or more of wireless communication subsystem(s) 1124.

Data processing system 1100 is provided for purposes of illustration and not limitation. A device/system/apparatus configured to perform the operations described herein may have a different architecture than illustrated in FIG. 11. The architecture may be a simplified version of the architecture described in connection with FIG. 11 that includes a memory capable of storing instructions and a processor capable of executing instructions. In this regard, data processing system 1100 may include fewer components than shown or additional components not illustrated in FIG. 1 depending upon the particular type of device that is implemented. In addition, the particular operating system and/or application(s) included may vary according to device type as may the types of I/O devices included. Further, one or more of the illustrative components may be incorporated into, or otherwise form a portion of, another component. For example, a processor may include at least some memory.

The terminology used herein is for the purpose of describing particular examples only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium includes an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, “data processing system” means one or more hardware systems configured to process data, each hardware system including at least one hardware processor programmed to initiate operations and memory.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment.

As defined herein, the phrase “in response to” and the phrase “responsive to” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc., may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the implementations described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the implementations described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the implementations described herein.

Certain aspects of the implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the implementations. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various implementations of the disclosed technology have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method, comprising:
generating, by an encoder of a transformer model, a user behavior embedding from user behavior data;
generating, by a semantic data generation model, semantic features from a received input;
generating a behavioral semantic embedding by processing the semantic features and the user behavior embedding through a cross-attention encoder;
generating control features by combining the behavioral semantic embedding with context features generated from context data; and
generating, by a music generation model, music based on the control features.

2. The method of claim 1, wherein the input is a visual content item, the method further comprising:
rendering the visual content item concurrently with the music.

3. The method of claim 1, wherein the input is a visual content item, and wherein the generating the semantic features comprises:
generating, from a visual channel of the visual content item, visual features by a visual encoder of the semantic data generation model.

4. The method of claim 3, wherein the generating the semantic features comprises:
generating, from an audio channel of the visual content item, audio features by an audio encoder of the semantic data generation model; and
generating, from a closed captioning channel of the item of visual content, closed caption features by a text encoder of the semantic data generation model.

5. The method of claim 4, further comprising:
pruning one or more of the semantic features prior to the generating the behavioral semantic embedding.

6. The method of claim 1, wherein the generating the user behavior embedding comprises:
generating a text embedding of the user behavior data using a text encoder model;
embedding time-based positional information in the text embedding; and
processing the text embedding comprising the time-based positional information through a transformer encoder to generate the user behavior embedding.

7. The method of claim 1, wherein the input is a visual content item, and wherein the generating the semantic features comprises:
generating, by a large vision-language model, text features from the visual content item.

8. The method of claim 1, further comprising:
receiving a personal media embedding specifying personal media preferences for the user; and
wherein the cross-attention encoder generates the behavioral semantic embedding by processing the semantic features, the user behavior embedding, and the personal media embedding.

9. A system, comprising:
one or more processors configured to execute operations including:
generating, by an encoder of a transformer model, a user behavior embedding from user behavior data;
generating, by a semantic data generation model, semantic features from a received input;
generating a behavioral semantic embedding by processing the semantic features and the user behavior embedding through a cross-attention encoder;
generating control features by combining the behavioral semantic embedding with context features generated from context data; and
generating, by a music generation model, music based on the control features.

10. The system of claim 9, wherein the input is a visual content item, and wherein the one or more processors are configured to execute operations including:
rendering the visual content item concurrently with the music.

11. The system of claim 9, wherein the input is a visual content item, and wherein the generating the semantic features comprises:
generating, from a visual channel of the visual content item, visual features by a visual encoder of the semantic data generation model.

12. The system of claim 11, wherein the generating the semantic features comprises:
generating, from an audio channel of the visual content item, audio features by an audio encoder of the semantic data generation model; and
generating, from a closed captioning channel of the item of visual content, closed caption features by a text encoder of the semantic data generation model.

13. The system of claim 12, wherein the one or more processors are configured to execute operations including:
pruning one or more of the semantic features prior to the generating the behavioral semantic embedding.

14. The system of claim 9, wherein the generating the user behavior embedding comprises:
generating a text embedding of the user behavior data using a text encoder model;
embedding time-based positional information in the text embedding; and
processing the text embedding comprising the time-based positional information through a transformer encoder to generate the user behavior embedding.

15. The system of claim 9, wherein the input is a visual content item, and wherein the generating the semantic features comprises:
generating, by a large vision-language model, text features from the visual content item.

16. The system of claim 9, wherein the one or more processors are configured to execute operations including:
receiving a personal media embedding specifying personal media preferences for the user; and
wherein the cross-attention encoder generates the behavioral semantic embedding by processing the semantic features, the user behavior embedding, and the personal media embedding.

17. A computer program product, comprising:
one or more computer readable storage mediums, and program instructions collectively stored on the one or more computer readable storage mediums, wherein the program instructions are executable by computer hardware to initiate operations including:
generating, by an encoder of a transformer model, a user behavior embedding from user behavior data;
generating, by a semantic data generation model, semantic features from a received input;
generating a behavioral semantic embedding by processing the semantic features and the user behavior embedding through a cross-attention encoder;
generating control features by combining the behavioral semantic embedding with context features generated from context data; and
generating, by a music generation model, music based on the control features.

18. The computer program product of claim 17, wherein the input is a visual content item, and wherein the generating the semantic features comprises:
generating, from a visual channel of the visual content item, visual features by a visual encoder of the semantic data generation model;
generating, from an audio channel of the visual content item, audio features by an audio encoder of the semantic data generation model; and
generating, from a closed captioning channel of the item of visual content, closed caption features by a text encoder of the semantic data generation model.

19. The computer program product of claim 17, wherein the generating the user behavior embedding comprises:
generating a text embedding of the user behavior data using a text encoder model;
embedding time-based positional information in the text embedding; and
processing the text embedding comprising the time-based positional information through a transformer encoder to generate the user behavior embedding.

20. The computer program product of claim 17, wherein the program instructions are executable by the computer hardware to initiate operations further comprising:
receiving a personal media embedding specifying personal media preferences for the user; and
wherein the cross-attention encoder generates the behavioral semantic embedding by processing the semantic features, the user behavior embedding, and the personal media embedding.
